(19) United States
(12) Patent Application Publication
(10) Pub. No.: US 2006/0016121 A1
(43) Pub. Date: Jan. 26, 2006

(54) Devices and methods for monitoring and/or controlling arthropods

(76) Inventors: James B. Ballard, Medford, NJ (US); Richard Ekins, Coatesville, PA (US); Robert Pepper, Bordentown, NJ (US)

Correspondence Address: PATENT ADMINISTRATOR;FMC CORPORATION, 1735 MARKET STREET, PHILADELPHIA, PA, 19103, US

(21) Appl. No.: 11/171,047

(22) Filed: Jun. 30, 2005

Related U.S. Application Data
(60) Provisional application No. 60/584,809, filed on Jul. 1, 2004.

(51) Int. Cl. A01M 1/20; A01M 1/02; A01M 17/00

(52) U.S. Cl. 43/132.1; 43/131

(57) ABSTRACT

The present invention provides arthropod monitoring or baiting stations that provide a simple and readily visible indication of arthropod activity within a station housing. The visible indication is accomplished through the use of a monitoring member that preferably comprises a colored material that visibly contrasts with the color of the interior of the housing, such that the color contrast between the monitor member and the interior of the housing aids in visually detecting the presence of arthropods within the housing.

### FIELD OF THE INVENTION

The present invention relates to the monitoring and/or controlling of arthropods such as termites and, in particular, to monitoring members that enable detection of arthropod activity within an arthropod monitoring or bait station.

### BACKGROUND OF THE INVENTION

Termites are well known throughout most areas of the world as insects that attack and destroy wooden structures. Subterranean termites most often enter structures from the surrounding soil to feed on wood or other cellulosic material of the structure and its contents. Many methods for killing termites have been employed over the years. One such method involves applying a toxicant (i.e., a material that kills or repels termites) to the soil in the vicinity of a structure that is to be protected from termites. Not only is this type of treatment labor intensive and raises issues about soil contamination, but the possibility exists that the application will not produce an adequate barrier to termite infestation.

Another approach to termite control involves the insertion of wooden stakes or some other suitable termite bait material into the soil around the periphery of the structure to be protected, monitoring the stakes for infestation, and then applying a toxicant to the soil only in those areas in which infestation is observed. This approach minimizes use of the toxicant, yet presents other problems. The bait stakes, for example, do not provide a continuous barrier around the structure, as they typically occupy limited area and, moreover, are separated from one another by a distance on the order of feet or even yards. Termite populations located in the soil can have difficulty locating the bait stakes in the first place, especially if the bait stakes are widely spaced and located on a predetermined interval irrespective of conditions around a structure conducive to termite attack, such as moist areas around a structure. Also, removal of the bait stakes can disrupt the system of passageways leading to the stakes that termites may have constructed and, in turn, can disrupt the flow of termites to a stake upon stake re-insertion. These problems are said to be addressed by U.S. Pat. Nos. 5,329,726 and 5,555,672, which disclose insertion into the ground of a stationary housing that not only contains a removable bait cartridge but also possesses a plurality of extensions which are said to intercept or obstruct the path of termites in the vicinity of the housing.

More recent developments have focused on the need to further minimize disturbance to termites feeding within a termite station. U.S. Pat. No. 5,950,356 discloses an apparatus and method wherein a non-toxic termite bait is fixedly attached to the sidewall of a housing and, after inspection of the sidewall of the housing for termite activity, toxic bait is introduced into the interior of the housing. This method is said to avoid the disturbances inherent in the use of a system of interchangeable monitoring and bait cartridges. U.S. Pat. No. 6,016,625 is said to disclose bait stations that contain a combination of stacked monitoring and baiting devices having an extractor means that can selectively move the termite monitoring and/or baiting devices.

Recent developments in the art require frequent inspection of termite monitoring and baiting systems. Typically, this inspection is carried out at designated time intervals by a Pest Management Professional (PMP). Each time a PMP must go to a site for inspection requires the expenditure of time and money. In addition, the current technology for detecting termites inside a monitor or bait station either involves expensive signaling mechanisms, usually of an electrical nature, or other complex mechanisms of questionable reliability. For example, U.S. Pat. No. 6,266,918 describes a mechanical device that displays a visual signal outside the housing of a monitor or bait station when a trigger is released by the feeding activity of wood-destroying insects. Similarly, U.S. Pat. No. 6,370,811 describes an apparatus that displays a flag member after a sufficient load force has been applied to a test element that has been weakened by termite activity. U.S. Pat. No. 5,877,422 describes a device comprising an alarm device, a relay device, and a detection apparatus. The detection apparatus electrically senses the presence of termites when the termites pass through openings connecting two internal chambers. This electrical signal is sent to a relay device, which in turn sends a signal to a monitoring center.

Detection methods involving visually inspecting the monitor or bait station present other problems. For example, visual inspection may disrupt the device if it involves pulling the device from the ground or by opening a lid. When termites are so disturbed, they often leave the area and may even leave a pheromone warning for other termites to avoid the area. See U.S. Pat. No. 5,899,018. To the extent the visual inspection is done through a transparent housing without removing or opening the device (see, U.S. Pat. No. 5,832,658), such inspection is complicated by mud or soil that tends to fill the device (such as, for example, soil brought into the station by ants), or uncertainty in determining whether or not the bait or attractant material has actually been subjected to termite activity.

### SUMMARY OF THE INVENTION

In one aspect, the present invention provides arthropod monitoring stations that comprise a housing having a first end, a second end, and a lateral wall extending between the first end and the second end. In such stations, the first end, second end, and lateral wall substantially define an interior portion of the housing, and at least one of the first end, the second end, and the lateral wall includes at least one aperture suitable for ingress or egress by an arthropod with respect to the interior portion of the housing and at least a portion of the first end is substantially transparent. Preferably, at least one base member (such as, for example, a block of wood) is disposed within the housing that comprises a material capable of being consumed by arthropods, a material capable of being penetrated by arthropods, a material capable of being transported by arthropods, or a material capable of killing arthropods. In addition, there is at least one monitor member (such as, for example, a paper disk) that is disposed within the housing between the base member and the first end and which is visible through the first end. The monitor member may also comprise a material capable of being consumed by arthropods, a material capable of being penetrated by arthropods, a material capable of being transported by arthropods, or a material capable of killing arthropods. Visual inspection through the first end of the housing of the removal of at least a portion of the monitoring member signifies the presence of arthropods.

Preferably, the monitor member comprises a colored material that visibly contrasts with the interior of the housing, such that the color contrast between the monitor member and the interior of the housing aids in visually detecting the presence of arthropods within the housing. In such an embodiment, the color contrast between the interior of the housing and the monitor member aids in detecting the extent to which arthropods have removed portions of the monitor member and, hence, enables one to determine that arthropods are present. Using such a color contrast provides an easy, reliable aid for visually detecting the presence of arthropods within the housing without disturbing the monitoring station and without the use of complex, moving mechanical parts or electrical devices.

The present invention also provides methods for either partially or completely implanting arthropod monitoring stations in soil. Also provided are methods for monitoring the stations of the invention for arthropod activity. Such methods comprise, for example, identifying an arthropod monitoring station of the present invention and determining the extent to which said monitor member has been removed by arthropods, and can further include adding and/or replacing station housings, base members, and/or monitor members.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed. In the drawings:

FIG. 1 shows an exploded view perspective of a monitoring station according to the present invention.

FIG. 2 shows a top view of the station of FIG. 1 looking through a first end of a monitor station housing.

FIG. 3 shows an exploded view perspective of a monitoring station according to the present invention.

### DETAILED DESCRIPTION OF ILLUSTRATIVE EMBODIMENTS

The present invention provides stations and methods for monitoring arthropods. As used herein, the term “monitoring” is intended to mean watching, inspecting, observing, or checking a person or thing, particularly an arthropod such as a termite. Thus, a device that enables its user to simply determine whether or not termites are present in an area of interest is deemed to be a monitoring device, irrespective of whether or not that device enables its user to perform some additional task such as, for example, killing the termites.

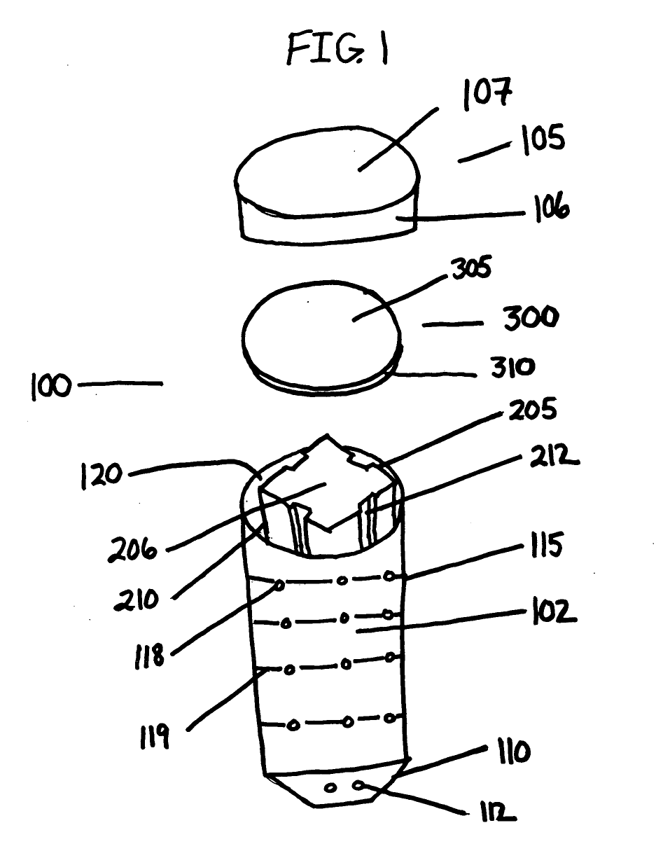

FIG. 1 shows an exploded view of a preferred arthropod monitoring station 100 according to the present invention comprising a housing 102 having a first end 105, a second end 110, and a lateral wall 115 extending between said first end and said second end. As shown in FIG. 1, first end 105, second end 110, and lateral wall 115 substantially define an interior portion 120 of said housing. Preferably, at least one of the ends 105 and 110 is removably attached to lateral wall 115 so as to provide access to interior portion 120. Any of the known structures suitable for removable attachment can be used. The ends, for example, can snap or screw over or into the housing lateral wall. For example, end 105 can screw into lateral wall 115 using threaded elements (not shown). A preferred means for removable attachment is one in which end 105 snaps over lateral wall 1115, as is the case in FIG. 1. Another preferred manner of removable attachment includes tamper-resistant type attachment, including, but not limited to, an end that is pushed down and twisted for removal and/or attachment. Alternatively, an end may be permanently affixed to lateral wall 115. Any of the known structures for permanent affixation may be used. Ends 105 or 110, for example, may be glued or otherwise bonded to lateral wall 115, or may be otherwise integral with lateral wall 115.

The ends and lateral wall may be fabricated from any of a variety of materials having suitable strength and rigidity including, without limitation, plastic (i.e., synthetic polymer), wood, plaster, concrete, asphalt, tile, brick, masonry, ceramic, metal, rigid polymeric foam, composites of two or more materials, and laminates of suitable sheet materials. It is preferred that they be fabricated from rigid or flexible plastic, preferably polyethylene or polystyrene, and more preferably polypropylene. The ends and lateral wall can be pressed, molded, extruded, or otherwise formed from several parts. For preferred applications of the present invention, at least a portion of the ends and/or the lateral wall are made of a transparent material such as glass or synthetic polymer to facilitate inspection of interior portion 120.

Housing 102 should have a lateral cross-section (i.e., a cross section taken perpendicular to lateral wall 115) that defines a closed surface shape such as, for example, a circle (as, for example, in FIG. 1), triangle, tetrahedron, pentagon, hexagon, heptagon, octagon, or more complex polygon. Ends 105 and 110 will typically have corresponding shapes, and preferably are either substantially in the form of a plate or have a somewhat more tapered, conical structure.

In certain embodiments of the present invention, at least one of ends 105 and 110 and lateral wall 115 includes at least one aperture suitable for ingress or egress by an arthropod with respect to interior portion 120 of the housing. In preferred embodiments, such as shown in FIG. 1, there are a plurality of apertures 118 in lateral wall 115 and a plurality of apertures 112 in end 110. As shown in FIG. 1, apertures 118 in lateral wall 115 preferably are disposed in offset horizontal rows to form a triangulated pattern. The apertures are typically 0.25 inches in diameter, but may be varied. The separation distance between any two apertures is from about 0.25 inches to about 2.0 inches, and preferably about 0.50 inches, measured from the edge of an aperture. In certain embodiments, lateral wall 115 may include substantially rectilinear grooves 119 that each connect apertures falling within a given row. Such grooves should have approximately equal depth and width, preferably about 0.125 inches each. Alternatively, the lateral wall can include substantially rectilinear raised ridges (not shown) that each connect apertures falling within a given row. Such ridges should have approximately equal width and height, preferably about 0.125 inches each. In other embodiments, the interior of lateral wall 115 may comprise a rough surface and/or contain grooves or ridges that arthropods may travel along.

The stations of the invention include at least one base member that is preferably removably positioned within the above-noted housing. FIG. 1 shows a representative base member 205 disposed within a housing 100 that can accommodate additional base members and materials. As exemplified by base member 205, base members according to the invention may include a first end surface 206, a second end surface (not shown), and a lateral wall 210 extending between the first end surface and the second end surface. In addition, the end elements or the members themselves may have a gripping element (not shown) to facilitate removal of a member from the housing. The gripping element may include a nail, knob, staple, or molded protrusion.

As shown in FIG. 1, the base member 205 is preferably disposed within housing 100 such that the lateral wall 210 of the base member is at least substantially parallel to lateral wall 115 of housing 100. The term “substantially parallel,” as used herein, is intended to refer to positioning two structures such that their respective longitudinal axes (as, for example, defined by lateral walls 115 and 210) either do not meet or meet to form an angle no greater than 45°. The base member can have a length equal to the length of the lateral wall 115 of the housing or the base member can only conform to a portion of the length of the lateral wall of the housing. Preferably, the base member has a length of at least about 50% of the length of the lateral wall of the housing, more preferably about 75%, and even more preferably 100%.

Base members according to the invention are formed from and/or contain materials capable of being consumed by arthropods, materials capable of being penetrated by arthropods, materials capable of being transported by arthropods, and/or materials capable of killing arthropods. Representative materials capable of being consumed by arthropods include cellulosic materials such as wood, cardboard (with or without wax treatment), fiberboard, paper, and sawdust. Typically, materials capable of being consumed by arthropods, as used herein, refer to materials that are not toxic, i.e. not capable of killing arthropods. Preferred materials of this type include wood and sawdust. In other embodiments, the material capable of being consumed by termites comprises a composition as disclosed in U.S. Pat. No. 5,573,760, which is incorporated herein by reference in its entirety. The materials may be used in the present invention in various forms, including, but not limited to, particles, pellets, granules, disks, or combinations thereof, and may be contained in bags or pouches that are made of a material capable of being consumed by arthropods.

Representative materials capable of being penetrated by arthropods include polymeric foams such polystyrene foam, chalk, sponge material, and wood. Representative materials capable of being transported by arthropods include polyurethane, soil, clay, and chalk. Representative materials capable of killing arthropods include but are not limited to, slow acting toxicants such as sulfluramid, hydramethylnon, avermectin, spinosad, nicotinoids (such as imidacloprid and acetamiprid), fipronil, chlorfenapyr, indoxacarb, flonicamid, borates, insect growth regulators, chitin inhibitors (such as hexaflumuron, lufenuron, and diflubenzuron), halofenicide, isothiozalone, sulfotine, juvenile hormone analogs, biological agents (e.g., spores, mycelium, mites, nematodes, or toxins), pyrethroids, protozoacides, and anti-bacterial agents. Preferred materials include flonicamid, acetamidprid, and chitin inhibitors.

Base members of the invention can be formed entirely from such materials (as, for example, in the case of a wooden block), or can be formed partially from such materials. For example, the base member may be a wooden block or tube or a fibreboard in which a material capable of killing arthropods is dispersed or sprayed, or the first end surface of a base member may be made or treated with a different material than the remaining portion of the base member.

The ends and lateral walls of base members according to the invention can be formed from any material, but are preferably made of material having suitable strength and rigidity. In embodiments in which the member is monolithic (as with wooden block 205), its end surfaces and lateral wall will be formed from one of the materials capable of being consumed by arthropods, capable of being penetrated by arthropods, capable of being transported by arthropods, and/or capable of killing arthropods.

Base members according to the invention should have a lateral cross-section (i.e., a cross section taken perpendicular to, for example, lateral wall 210) that defines a closed surface shape such as, for example, a circle, triangle, tetrahedron (as, for example, in FIG. 1), pentagon, hexagon, heptagon, octagon, or more complex polygon. End surfaces of the base members will typically have corresponding shapes.

Preferred base members according to the invention include monolithic rectilinear blocks (e.g., 205), cylindrical monolithic blocks, and cylindrical tubes. Particularly preferred monolithic blocks are those that include at least one substantially rectilinear groove (e.g., 212) on its lateral wall, preferably along substantially the entire length of its lateral wall. Such grooves should have approximately equal depth and width, preferably about 0.125 inches each.

In another embodiment, the base member may be in the form of a slotted dowel that serves as a longitudinal axis for a plurality of spaced apart plates that extend radially toward the lateral wall of the housing. The plates have a first face and a second face substantially opposite the first face and are substantially planar and parallel, although they need not be. One or more of these plates can be located at various points along the length of the base member. In preferred embodiments, the plate or plates comprise a plurality of grooves or ridges on a surface of the first and/or second face of the plate. These grooves or ridges define at least one containment channel. The grooves or ridges can be of virtually any size and shape. While not wishing to be limited to any particular theory, the grooves or ridges are believed to direct arthropods along containment channels toward the base members as well as from the base members to the lateral wall of the housing. The widths of the grooves preferably are about 0.03 inches to about 0.5 inches, and more preferably about 0.125 inches. In certain embodiments, the plate is formed from a synthetic polymer that is resistant to arthropod consumption and in others the plate may be formed of a material capable of being consumed by arthropods. The plate can also comprise a material capable of being penetrated by arthropods, such as a polymeric foam.

Depending on the respective shape of the housing and the base members, the interior of the housing can comprise empty space between the base member and the housing, as well as between the base members themselves in those embodiments including multiple base members. In some embodiments, it is preferable to partially or completely fill this space to, for example, provide points of contact with the housing and the base members that enable the arthropods to travel between the housing and the base members and from base member to base member. Another reason for filling this space is to provide support for the members disposed within the housing and to preferably maintain the base members in a substantially parallel configuration. The material used to fill the housing can be disposed between the housing and one or more of the members, beneath one or more of the members, or just between the members themselves. Representative filling materials include those capable of being consumed by arthropods, capable of being penetrated by arthropods, capable of being transported by arthropods, and/or capable of killing arthropods. Preferred filling materials include wood, cardboard, paper, polymeric foam (including expanded and/or extruded polystyrene foam), polyethylene and/or any of these materials optionally treated with a substance capable of killing arthropods. Other types of materials that permit movement of arthropods include rough plastic surfaces shaped as horizontal plates or a slotted, rough mass of plexiglass. In addition, the filling material may comprise a composition as disclosed in U.S. Pat. No. 5,573,760, that may be placed in the interior of the housing and/or at the bottom of second end 110. These materials can be in any of a variety of shapes, including without limitation, powders, flakes, chips, sticks, slats, and dowels.

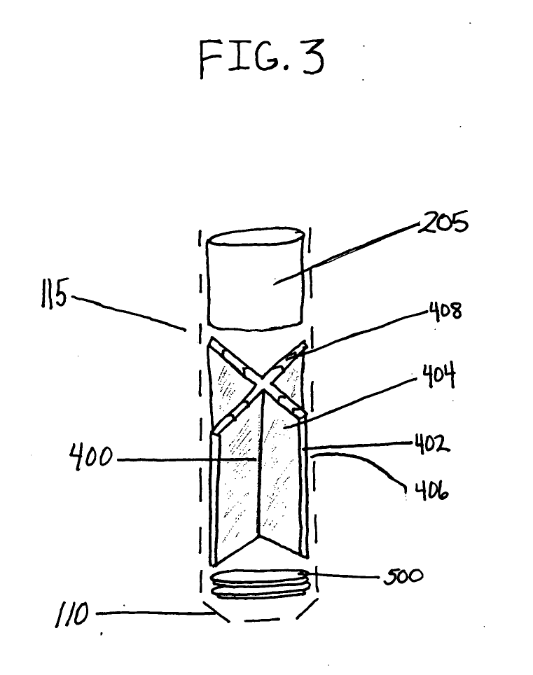

As generally shown in FIG. 3, rigid, substantially vertical support structures can be disposed between, below, or above one or more base members. Such structures can have any of a variety of cross-sectional shapes, and generally have a length less than the length of the lateral wall of the housing. In the embodiment shown in FIG. 3, support structure 400 has an X-shaped cross-section and supports the base member 205 from below. Such a structure can, of course, have a different cross-section such as, for example, one having the shape of a Y, +, or O. In embodiments having multiple base members, the support structure may be disposed between base members to form multiple compartments that support the base members. The shape, length and cross-section of the support structure can vary depending on the number of members utilized and/or the application desired. Alternative support structures may also be utilized. These may include, for example, protrusions from lateral wall 115 extending into the interior of the housing on which one or more base members may be supported. In addition, a base member may be supported by a ring or plate structure that extends across the interior of the housing. Such ring or plate structures may include extensions that extend toward second end 110 of the housing and on which arthropods may travel.

As shown in FIG. 3, outer edge 402 between faces 404 and 406 of support structure 400 may conform to the lateral wall of the housing 115. These faces can have one or more preformed pores or openings through which arthropods may travel. Alternatively (and as shown), faces 402 and 404 have no openings. Support structures of the type shown in FIG. 3 can be constructed from a corrugated or solid material such as wood, cardboard, paper, polymeric foam (including expanded and/or extruded polystyrene foam), polyethylene, plastics, or other synthetic polymers. Preferably, structure 400 is constructed from a corrugated synthetic polymer having substantially hollow passageways 408 extending substantially throughout the support structure's length. In preferred embodiments, the support structures comprise a plurality of grooves, for example, on a surface of the first and/or second face of structure 400. These grooves define at least one containment channel and can be of virtually any size and shape. Alternatively, structure 400 may comprise a plurality of ridges on a surface of its first and/or second face. These ridges may define at least one containment channel and can be of virtually any size and shape. While not wishing to be limited to any particular theory, the grooves and/or ridges are believed to direct arthropods along containment channels toward the base member as well as to and from the base member to the lateral wall 115 of the housing. In the particular embodiment of FIG. 3, a filling material may also be placed in the interior of the housing, for example, at the bottom of second end 110 and below support structure 400, such as one or more chips 500. Preferably, the chips are made of materials capable of being consumed by arthropods, such as the composition disclosed in U.S. Pat. No. 5,573,760.

Another aspect of the present invention, as shown in FIG. 1, includes at least one monitor member 300 that is disposed within the housing 100 between the base member 205 and the first end 105 and which is visible through the first end. As with the base member, the monitor member may also comprise a material capable of being consumed by arthropods, a material capable of being penetrated by arthropods, a material capable of being transported by arthropods, or a material capable of killing arthropods.

Monitor member 300 can be integral with the first end 105 of the base member 205, or can be an entirely separate structure, as shown, for example, in FIG. 1. As shown in FIG. 1, monitor member 300 has a first face 305 and a second face (not shown) substantially opposite first face 305, and is preferably substantially planar. The monitor member 300 should have a lateral cross-section that substantially defines a closed surface shape such as, for example, a circle (as, for example, in FIG. 1), triangle, tetrahedron, pentagon, hexagon, heptagon, octagon, or more complex polygon. Typically, although not required, the housing 100, first end 105, base member 205, and monitor member 300 will have corresponding shapes. In preferred embodiments, the base member and monitor member have substantially the same lateral cross section that defines substantially the same closed surface shape. In other embodiments, the lateral cross section of the monitor member may be greater than that of the base member, such that the base member is not visible by inspection through the first end 105.

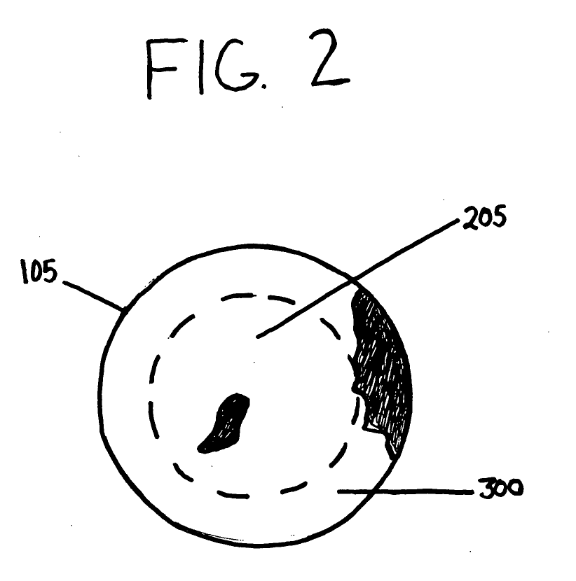

As shown in FIG. 1, monitor member 300 has an outer edge 310 between its first face 305 and second face. In the embodiment shown in FIG. 1, the first face 305 and second face of monitor member 300 are both substantially planar and parallel, although they need not be. As shown in FIG. 1, the monitor member 300 has a thickness (i.e., distance between first face 305 and the second face). In certain embodiments, the thickness may range from about 0.004 to about 0.25 inches. For example, the thickness may be about 0.25 to about 0.125 inches, about 0.062 to about 0.016 inches, and, in certain preferred embodiments, about 0.008 to about 0.004 inches. Although not wishing to be limited to any particular theory, it is believed that if the monitor member is too thick, arthropods traveling to the monitor member from below the second face of the monitor member will only remove (e.g., consume, penetrate, or transport) material from the second face of the monitor member without traveling to the first face of the monitor, so that any such removal of the monitor member would not be visibly detectable by inspection through the first end 105 of the first face 305 of the monitor member, or such removal would be substantially delayed. As shown in FIG. 2, the outer edge 310 of monitor member 300 preferably extends out to and/or conforms to the lateral wall of the housing 115, or alternatively, to the outer edge 106 of the first end element 105. As noted above, in other embodiments the monitor member 300 may be integral with the base member. In such embodiments, the monitor member may comprise the first end surface 206 of the base member.

Without wishing to be bound by any particular theory, it is believed that the arthropods that enter the housing will eventually travel from the base member to the monitor member. In order to increase the chances that the arthropods will reach (and remove portions of) the monitor member, it is preferred that the monitor member be made of or be treated with a material that is more attractive to arthropods than the base member. Examples of preferred materials and/or treatments for the monitor member include attractants, feeding stimulants, and arrestants. While not wishing to be limited to any particular theory, it is believed that grooves 212 also help direct arthropods along the length of the base member toward the monitor member 300. In addition, a hole may be drilled through the center of the base member 205 along its longitudinal axis, as arthropods have a tendency to travel along such an opening toward the monitor member 300.

Monitor member 300 is preferably in contact with the base member 205. The contact may be direct or indirect, but is preferably direct, e.g., at least a portion of the second surface of the monitor member is in physical contact with the first end surface 206 of the base member. Alternatively, other materials capable of being consumed or penetrated by arthropods may be situated between the base member and monitor member. In other embodiments, the monitor member may be within about 0.25, about 0.125, about 0.062, or about 0.031 inches of the base member. Without wishing to be bound by any particular theory, it is believed that arthropods traveling on or through the base member toward the monitor member will more readily encounter the monitor member and remove portions thereof if provided uninterrupted access to the monitor member. Maintaining contact between the base member and monitor member should also help minimize any tendency of arthropods to fill gaps or spaces between the first end surface of the base member and monitor member with mud or soil. It is therefore preferable to minimize gaps or spaces between the base member and monitor member. More preferably, the first end surface of the base member is substantially flush with the second surface of the monitor member.

In certain embodiments the monitor member may be affixed to the base member. Any of the known means for affixation can be used. The monitor member, for example, can be stapled, tacked, or glued onto or into the first end surface 206 of the base member. As will be recognized, the gripping element (not shown) may be part of the means for affixation, as in the case of a tack, nail, or staple that affixes the monitor member to the base member and protrudes from above the first surface of the monitor member. The monitor member may also be held in contact with the base member by pressure, such as, for example, with a spring mechanism.

In alternative embodiments, the monitor member may be in contact with and/or affixed to the first end 105. In those embodiments where the monitor member is affixed to the first end, any of the known means for affixation may be used, including, but not limited to, glue or other adhesive. In addition, the dimensions of the monitor member may be designed so that it snugly fits against the top end 107 of the first end 105, and the outer edge 310 of the monitor member extends to and/or conforms with the outer edge 106 of the first end.

Another aspect of the present invention relates to the use of contrasting coloration to aid in visually detecting the presence of arthropods within the housing. Preferably, the monitor member comprises a colored material that visibly contrasts with the color of the interior of the housing, such that the color contrast between the monitor member and the interior of the housing aids in visually detecting the presence of arthropods within the housing. In such an embodiment, the color contrast between the interior of the housing and the monitor member is visible when, for example, the interior of the housing is exposed through removal of at least a portion of the monitor member by arthropods within the housing. In this case, the interior of the housing would comprise any material or space that is exposed upon removal of the monitor member.

Any visible contrast colors may be employed. Preferred colors include fluorescent colors, such as fluorescent green, orange, or yellow. The color may be applied to the monitor member by various, well-known methods, including, but not limited to, paint or spray paint. In subterranean embodiments, the interior of the housing will appear dark looking through the first end of the housing, such that the monitor member should have a lighter color to provide contrast. In those embodiments where the monitor member has substantially the same lateral cross section and dimensions as the first end surface 206 of the base member, it is preferred that the monitor member be visibly contrasted to the color of the base member. In preferred embodiments, the monitor member is made of a fluorescent material that provides a highly visible contrast color through the first end of the housing. As seen in FIG. 2, by removing a portion or portions of the monitor member, the color contrast of the monitor member against the exposed portion of the interior of the housing (and any materials within the interior) becomes readily visible, and provides an indication of arthropod activity. For purposes of visual inspection, it is preferred to minimize the distance between the monitor member and the first end 105 of the housing, so that the monitor member can be more readily visible through the transparent first end.

As evident from the disclosure herein, the present invention involves a monitoring station that provides various alternatives to monitor and/or control arthropods. The various types of base members and monitor members that can be disposed within the housing preferably provide an operator with increased flexibility in treating any particular arthropod infestation situation. Moreover, the multiple members within the housing and the various functions each member can serve provide many alternatives for minimizing interruption and disturbance of arthropod feeding within the housing starting at the time of station installation and throughout the monitoring and/or controlling activities. In this respect, reference is made to WO 02/32223 A1, incorporated herein by reference.

Generally, one or more stations 100 are implanted in the soil, or within an outer housing (not shown) that is implanted in the soil, although such stations can be adapted for above-ground use. Typically, the station or stations are implanted in the soil within about 1-2 feet of a building, preferably one suspected of suffering from arthropod infestation. If two or more stations are implanted, the stations are generally located within 20 feet or less of one another.

In one embodiment, the station is implanted in the soil such that a portion of the lateral sidewall 115 of the housing extends above the soil. Typically, the lateral sidewall will extend to such a point above the soil that a PMP or other operator can locate the station and inspect or access the station without having to disrupt its position in the soil. At the same time, the extension preferably is not at a height that would cause interference with a lawnmower or other above-ground devices.

In one embodiment of the present invention, upon identifying a station, a PMP or other operator may determine the extent to which the monitor member has been removed by arthropods. Preferably this is accomplished by visibly inspecting the monitor member through a transparent portion of the first end or lateral wall of the housing. More preferably, the extent to which the monitor member has been removed by arthropods is determined by the color contrast between the monitor member and the interior of the housing. Such a method provides a highly visible and reliable mechanism for determining if a station has been attacked by arthropods without the need to disrupt the station or its contents. Alternatively, an operator would be able to manipulate one of the ends (e.g., 105) that is removably attached to lateral wall 115 so as to provide access to the interior portion 120 of the housing for purposes of inspecting the monitoring member.

In general, the stations of the invention will be initially inspected for arthropod activity, especially in areas where arthropods have not previously been detected. Use of the stations of the present invention can be understood by reference to several examples. It is to be understood, however, that other combinations and selective placement and replacement of housings, base members, and/or monitor members is contemplated within the scope of the present invention, as the flexibility offered by the present invention is one of its advantages. Indeed, the members and materials can be disposed in any number of sequential arrangements in the housing.

Initially, it is preferred that a station of the invention comprise members that serve a monitoring function. For example, base member 205 may comprise a wooden block and monitor member 300 may also be composed of a material that is attractive, non-toxic and/or nonrepellant to arthropods. Monitor member 300 is periodically inspected for arthropod activity. As previously disclosed, inspection is typically performed by looking through a transparent first end 105 to monitor member 300.

Upon detection of arthropod activity within the housing, and in particular within monitor member 300, one or more base members 205 can be removed and replaced with a base member having a material capable of killing arthropods, i.e. a baiting base member. In other embodiments, upon detection of arthropod activity, an additional baiting base member may be inserted within the housing. In this manner, arthropods previously feeding or present within a pre-exisiting base member or monitor member will be relatively undisturbed upon placement of a new baiting base member within the housing to provide control of the arthropod population. In heavy infestation areas, two or more baiting base members can be disposed within the housing. Alternatively, if termite activity is evident, the entire original station may be removed from the ground and replaced with a new station containing a material that is capable of killing arthropods or one or more stations containing a material that is capable of killing arthropods may be inserted into the ground proximate to the location of the original station, e.g., from about 2 to about 24 inches from the original station.

In embodiments wherein the monitor member is affixed to the removably attached first end of the housing, the first end and the monitor member may be removed and replaced with a different first end having a second monitor member affixed thereto. The second monitor member may include a material capable of killing arthropods. In those embodiments where the monitor member is affixed to the base member, the base member may be removed and replaced with a second base member having a second monitor member affixed thereto and the second base member and/or second monitor member may include a material capable of killing arthropods.

In addition, the station housing can initially contain one or more baiting base members or baiting monitor members, particularly if detection is not a primary concern or if an area is known to be infested with arthropods. In such an embodiment, the station, baiting base member, and/or baiting monitor member may be removed or replaced upon visual identification of infestation or after a designated time interval. As is evident from the above examples, the members of the invention can be arranged in various combinations and substituted for one another depending on the particular arthropod infestation situation. The substitution of a member or the insertion of a member can be carried out without substantial disturbance to the arthropods already present within the station housing. In addition, the removal and/or insertion of one member can take place without disturbance to another member and the arthropods that can be present therein.

The apparatus and methods herein can be combined with other methods and apparatus directed to monitoring and/or controlling other insect pests, such as ants. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

What is claimed:

1. An arthropod monitoring station comprising:
a housing having a first end, a second end, and a lateral wall extending between said first end and said second end, wherein;
said first end, second end, and lateral wall substantially define an interior portion of said housing;
at least one of said first end, said second end, and said lateral wall includes at least one aperture suitable for ingress or egress by an arthropod with respect to said interior portion of said housing, and at least a portion of said first end is substantially transparent;
at least one base member disposed within said housing that comprises a material capable of being consumed by arthropods, a material capable of being penetrated by arthropods, a material capable of being transported by arthropods, or a material capable of killing arthropods;
at least one monitor member that is disposed within said housing between said base member and said first end and is visible through said first end, said at least one monitor member comprising a material capable of being consumed by arthropods, a material capable of being penetrated by arthropods, a material capable of being transported by arthropods, or a material capable of killing arthropods.

2. The station of claim 1 wherein the monitor member is in contact with said base member.

3. The station of claim 1 wherein the monitor member is integral with said base member.

4. The station of claim 1 wherein the monitor member is substantially planar.

5. The station of claim 1 wherein the monitor member comprises a first face, a second face opposite said first face, and an outer edge between said first face and said second face.

6. The station of claim 1 wherein said housing, said base member, and said monitor member have a lateral cross-section substantially defining a closed surface shape.

7. The station of claim 6 wherein said shape is selected from the group consisting of circles, triangles, tetrahedrons, pentagons, hexagons, heptagons, and octagons.

8. The station of claim 6, wherein said base member and said monitor member have a lateral cross-section substantially defining a closed surface shape and said shapes and cross-sections are substantially the same.

9. The station of claim 6, wherein the lateral cross section of said monitor member is greater than the lateral cross section of said base member.

10. The station of claim 1 wherein the monitor member is a paper disk.

11. The station of claim 1 wherein said base member comprises wood or cardboard.

12. The station of claim 1 wherein said base member is a substantially monolithic mass of material.

13. The station of claim 12 wherein said mass is a substantially rectilinear block or a substantially cylindrical block.

14. The station of claim 13 wherein said block includes at least one groove on its surface.

15. The station of claim 13 wherein said base member is a block of wood.

16. The station of claim 1 wherein the monitor member comprises a colored material that visibly contrasts with the color of the interior of said housing.

17. The station of claim 1 wherein the monitor member comprises a colored material that visibly contrasts to the color of the base member.

18. The station of claim 16 wherein the monitor member is a fluorescent color.

19. The station of claim 1 wherein said first end is removably attached to said lateral wall of said housing.

20. The station of claim 1 wherein said monitor member is in contact with said first end of said housing.

21. The station of claim 20 wherein said monitor member is affixed to said first end.

22. A method comprising implanting at least one station housing of claim 1 in soil.

23. The method of claim 22 wherein the lateral wall of said station housing extends above said soil.

24. A method comprising the step of identifying a station of claim 1 and determining the extent to which said monitor member has been removed by arthropods.

25. The method of claim 24 wherein determining the extent to which said monitor member has been removed by arthropods is determined by the color contrast between the monitor member and the interior of the housing.

26. The method of claim 24 further comprising placing at least one additional base member in said housing.

27. The method of claim 24 further comprising removing at least one of said base members from said housing.

28. The method of claim 27 further comprising disposing at least one additional base member in said housing in place of said removed base member.

29. The method of claim 24 wherein at least one of said base members is a block of wood, further comprising:
removing said block of wood from said housing; and
replacing said block of wood with a replacement member.

30. The method of claim 29 wherein said replacement member includes a material capable of killing arthropods.

31. The method of claim 24 wherein the station is removed and replaced with another station containing a material that is capable of killing arthropods

32. The method of claim 24 wherein an additional station containing a material capable of killing arthropods is positioned proximate to the original station.

33. The method of claim 24 comprising the steps of removing said first end and said monitor member and positioning a further end element and monitor member in their place.

34. The method of claim 33 wherein said further monitor member includes a material capable of killing arthropods.
